(19) United States
(12) Patent Application Publication
(10) Pub. No.: US 2013/0239417 A1
(43) Pub. Date: Sep. 19, 2013

(54) HAND HELD CABLE CUTTER

(71) Applicant: Raymond Disantis, Willoughby Hills, OH (US)

(72) Inventor: Raymond Disantis, Willoughby Hills, OH (US)

(73) Assignee: The National Telephone Supply Company, Cleveland, OH (US)

(21) Appl. No.: 13/799,584

(22) Filed: Mar. 13, 2013

Related U.S. Application Data
(60) Provisional application No. 61/610,632, filed on Mar. 14, 2012.

(51) Int. Cl. B26B 13/00; B23D 29/02; H02G 1/00

(52) U.S. Cl. CPC B26B 13/00; H02G 1/005; B23D 29/023
USPC 30/254

(57) ABSTRACT

A hand held cable cutter has a first cutter half having a first cutting head with a first jaw having a first cutting blade formed on a first edge of the first jaw. A first pivot portion is formed in the head. A second cutter half has a second cutting head with a second jaw having a second cutting blade formed on a first edge of the second cutting blade. A second pivot portion is formed in the second head. The first and second cutting blades each has a cutting profile formed between the pivot portion and the first cutting edge and a root formed between a second cutting edge and the first pivot portion. The root and profile of the first and second cutting blades each form an overlap between the first and second cutter blades when the cutter is in a closed position.

### CLAIM OF PRIORITY

This application claims priority to application Ser. No. 61/610,632, filed on Mar. 14, 2012, the entirety of which is hereby incorporated by reference.

### BACKGROUND OF THE DISCLOSURE

Cable cutters and cable shears of varying types are used for cutting pipes, cables, wires and leads made of copper, steel, glass fibers, or other material.

Existing cable cutters include two intersecting levers articulated by a pivot joint. Each of the two levers which are to be actuated by one hand has a cutting jaw formed above the joint and a handle formed below the joint. Because of the long handles, the user can exert relatively high cutting pressures. In one-handed operation, however, only wires having small cross-sections may be cut because the handwide opening of the handles to accommodate the hand of the user will only permit limited opening of the cutting jaws.

The two intersecting levers are articulated by a common first pivot joint where each of the levers has a handle in its lower section and a cutting jaw in its upper section. That is, the levers have two parts, a front lever section forming the cutting jaw and a back lever section forming the handle. The lever sections are articulated by the pivot joint and are interlockable relative to each other in at least two distinct angular positions.

Many of the cutters have cutting jaws that open or spread apart wide enough to allow cutting of 0.25 inch diameter wire rope. The handles can open to around 7 inches or so to allow a continuous one handed operation and grip. The cutters are generally made up of two symmetrical halves fastened together by a pivot sub-assembly. The mechanical advantage is determined by the length ratio of the handle lever to the jaw lever. Given the restriction that the cutters must be operated in a one handed fashion, the dimensions of the handle lever arm is relatively the same for all cutters and therefore the moment about the pivot is the same. Given this, the mechanical advantage for cutting the wire rope is wholly dependent on the profile of the cutter jaw as it relates to the pivot.

Thus, there exists a need for a hand held cutter which has a mechanical advantage resulting from a short lever arm.

Most hand held wire rope cutting tools have some type of positive stop for the closed position and some type of stop for the open position. One variation of a cutter has a formed handle riveted to a stamped jaw head. This same variation of cutter has both stops built into the soft handle. The disadvantage of having hard materials stop on soft materials is that the soft material will wear more rapidly with continued use.

Other one piece cutters have closed position stops built into the handles below the head. These stops also serve a double function in that they integrate a sleeve crimper. A problem with these dual function stops is that have a pinch point in the area where the hand is placed which could harm the user.

Thus, there exists a need for a hand held cable cutter which has positive stops for both open and closed positions formed integrally with the head and of the same hardness material as the head.

### SUMMARY OF THE DISCLOSURE

In accordance with one aspect of the disclosure, a hand held cable cutter has a first cutter half which has a first cutting head with a first jaw having a first cutting blade formed on a first edge of the first jaw; a first pivot portion formed in the head; a second cutter half having a second cutting head with a second jaw having a second cutting blade formed on a first edge of the second cutting blade; a second pivot portion formed in the second head; and wherein the first cutting blade has a cutting profile formed between the first pivot portion and said first cutting edge of the first cutting blade and a root formed between a second cutting edge of the first cutting blade and the first pivot portion, wherein the second cutting blade has a cutting profile formed between the second pivot portion and the first cutting edge of the second cutting blade and a root formed between a second cutting edge of the second cutting blade and the second pivot portion, wherein the root and profile of the first cutting blade and the root and profile of the second cutting blade form an overlap between the first and second cutter blades when the cutter is in a closed position.

In accordance with another aspect of the disclosure, a first lever arm is formed between the pivot portion of the first cutting head and an outer edge of the first handle portion in a longitudinal direction.

In accordance with another aspect of the disclosure, a second lever arm is formed between the pivot portion of the first cutting head and an outer edge of the first handle portion in a transverse direction.

In accordance with another aspect of the disclosure, a mechanical advantage is defined by the first lever arm divided by the second lever arm times the handle force which equals jaw force.

In accordance with another aspect of the disclosure, the first cutter half and the second cutter half each has integrated stop portions formed in the first and second cutting heads to limit movement of the cutter halves to an open or closed position.

Other advantages and aspects of the disclosure will become apparent upon a reading and understanding of the following description.

### BRIEF DESCRIPTION OF THE DRAWINGS

FIG. 1 is a top plan view of the jaw half of the cutter in accordance with a preferred embodiment of the present disclosure;

FIG. 1A is a side elevational view of the cutter half of FIG. 1;

FIG. 2 is an enlarged top plan view (Detail A of FIG. 1) illustrating the integrated stop surfaces machined into the head of the jaw of FIG. 1;

FIG. 3 is a perspective view of the jaw half of FIG. 1;

FIG. 4 is a top plan view of the cutter assembly of the present disclosure showing two jaw halves in the full open position showing a minimum jaw opening and the handle opening;

FIG. 5 is a top plan view of the cutter assembly of the present disclosure in a fully closed position;

FIG. 5A is an enlarged top plan view of Detail B of FIG. 5 illustrating the overlap required for a complete cut;

FIG. 6 is a top plan view of the cutter assembly mid-way through a cut; and

FIG. 6A is an enlarged top plan view of Detail C of FIG. 6 illustrating the profile geometry to squeeze the wire rope into a triangular shape with two corners defined by radius as the cut is being made.

### DETAILED DESCRIPTION OF THE DISCLOSURE

The present disclosure relates to hand held cable cutters that offer improved mechanical advantage by virtue of a short lever arm as defined by the distance from a pivot to a root of a cutter profile. The cutter also has integrated positive stops formed in the head for both open and closed positions.

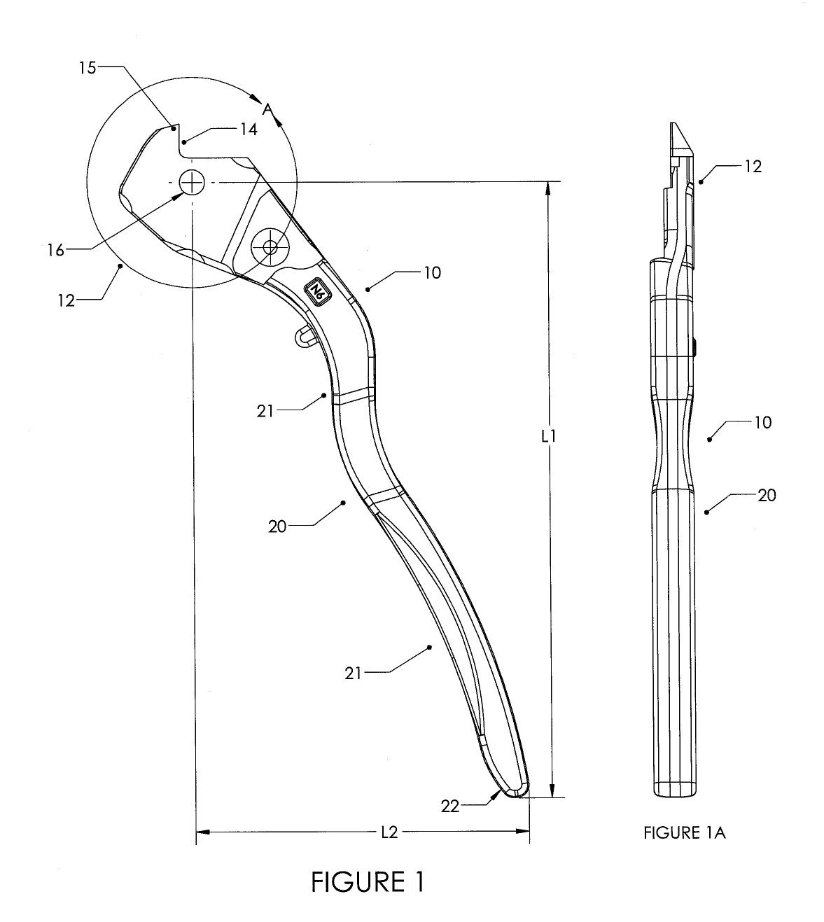

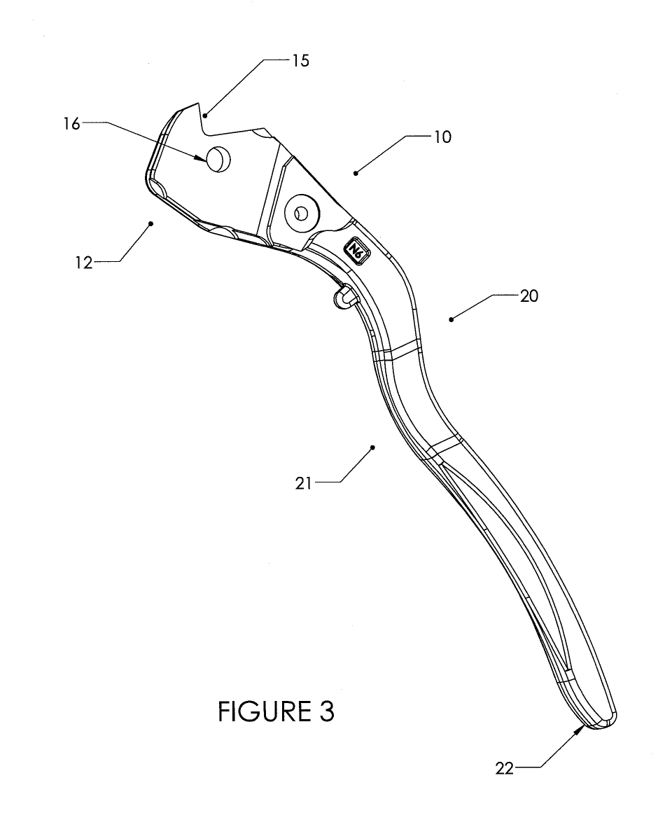

Referring now to FIGS. 1-6, a preferred embodiment of the disclosure is shown. More particularly, referring to FIGS. 1 and 3, a cutter half 10 is shown. The cutter half has a cutting head 12 at one end having a jaw 14 with a cutting blade 15 and a pivot opening or hole 16 formed therein. The cutter half and head are preferably fabricated from a steel alloy which has been hardened. Various alloys and methods of hardening are also contemplated by the disclosure. An ergonomic handle portion 20 extends from the cutting head and has several curves forming a gripping position 21 for the hand of the user. A first dimension L1 formed from the pivot hole to the bottom edge 22 of the handle is preferably about 6.10 inches in a longitudinal direction. A second dimension L2 from the pivot hole to edge 22 of the handle in a transverse direction is about 3.31 inches. Other dimensions are also contemplated by the disclosure.

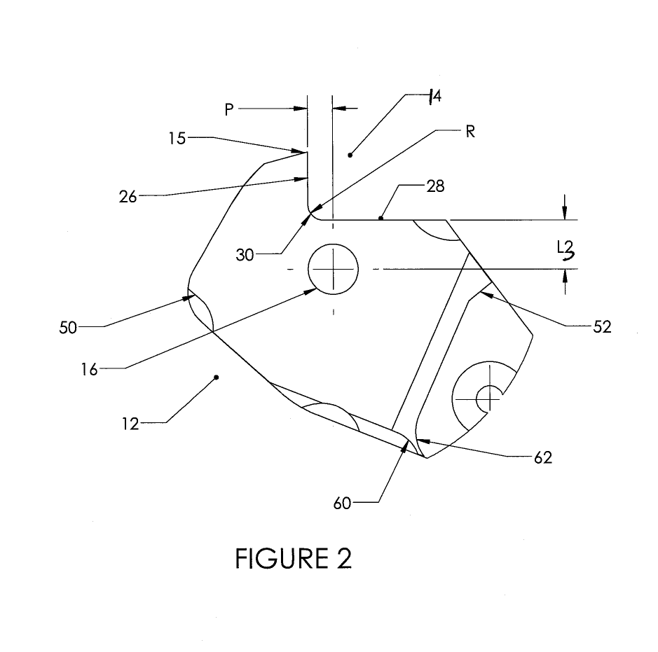

Referring now to FIG. 2, an enlarged view of the cutting head 12 shows a cutter profile P of about 0.125 inches formed between the pivot hole 16 and a first vertical cutter edge 26. A root dimension L3 of about 0.242 inches is formed between a second horizontal cutter edge 28 of the cutter profile and the pivot hole. A radius R of about 0.079 inches is formed at a corner of the cutter profile between edges 26 and 28.

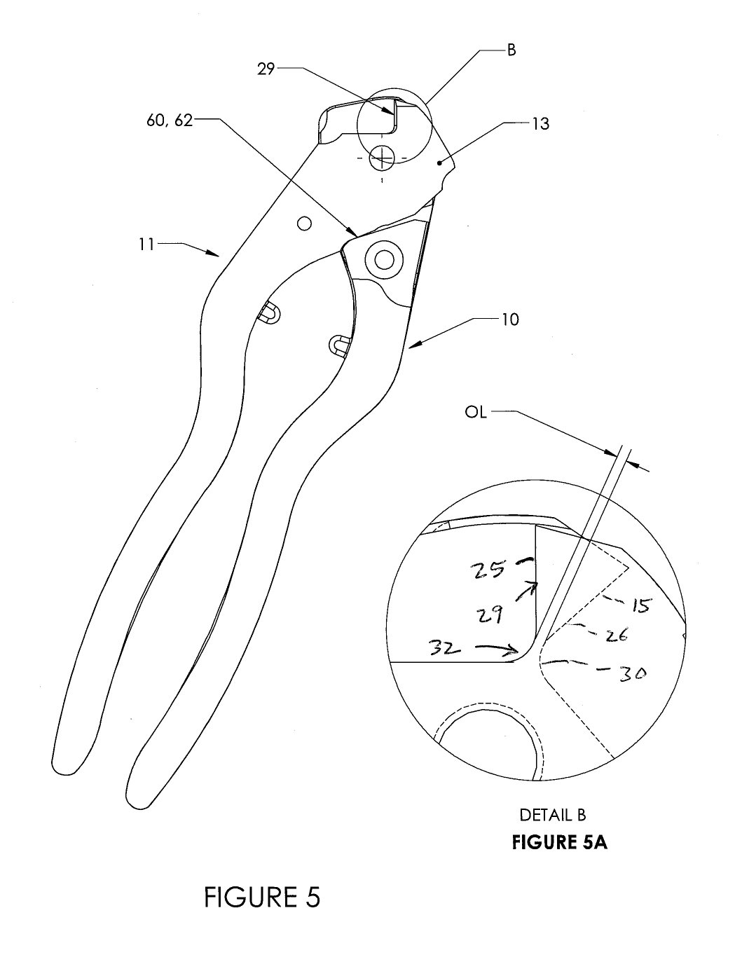

Referring to FIG. 5, the root dimension L3 (of about 0.242 inches) combined with the radius R (of about 0.079 inches) and the profile P dimension (of about 0.125 inches) allows full tool closure with significant cutter blade overlap about (i.e, about 0.025 inches) between two cutter halves 10, 11 and the required minimum 0.25 inch jaw opening when the cutter is closed. By comparison, other cutters have root dimensions L3 of 0.31 inches or more.

The cutter profile also incorporates the necessary profile geometry to squeeze the wire rope into a triangular shape with two corners 30, 32 defined by the radius R as the cut is being made (see FIG. 5A). This feature is common to most cutters as it provides a quality finished cut on the wire rope. The major difference is that the cutter profile of the present disclosure has an improved mechanical advantage.

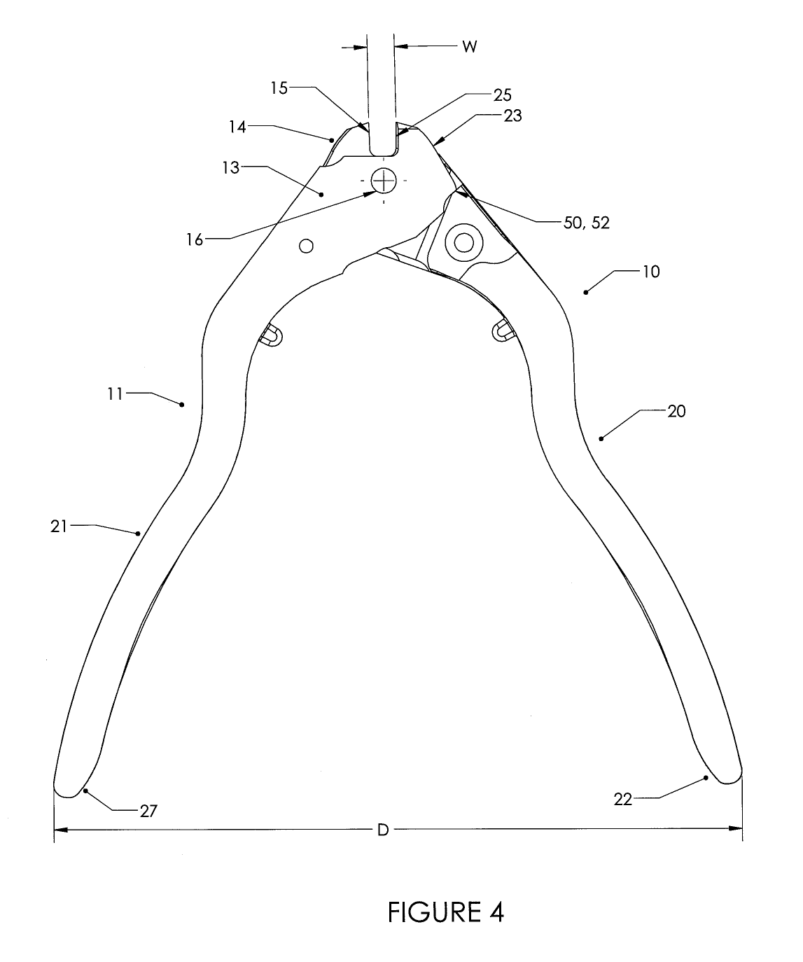

Referring now to FIG. 4, an assembled cable cutter includes a first cutter half 10 and a second cutter half 11 which may be turned crosswise relative to each other in a pivot joint 16. The second cutter half 11 has similar dimensions as the first cutter half. The first cutter half has a first handle 20 and a first cutting jaw 14 with a cutting blade 15, the second cutting half has a head 13, a second handle 21 and a second cutting jaw 23 having a cutting blade 25. The handles and the cutting jaws are arranged at opposite ends of the levers whereas the first pivot joint with the corresponding axis of rotation is located between the handles and the cutting jaws.

The mode of function of the cable cutter according to the disclosure is shown in FIGS. 4 to 6. The cable cutter is preferably used for cutting wires or cables. Wires or leads are no obstacle for the cable cutter and can be cut in one-hand operation because, owing to the different angular positions to be adopted by the jaw sections, varying opening widths W (such as 0.27 inches, see FIG. 4) between blades 15, 25 of the cutting jaws may be obtained. The ergonomic handles retain an approximate distance D between them when in an open position of about 7 inches (such as 6.82 inches) between the edges 22, 27 such that they may still be grasped and used with one hand.

For cutting a wire or cable, the cable cutter is first brought into the fully opened position shown in FIG. 4, and the work piece (not shown) to be cut is inserted between the cutting blades 15, 25. When the first half and the second half are pressed together, the cutting jaws will move toward each other. As shown in FIGS. 5 and 5A, the edges 26, 29 of blades 15, 25 eventually have an overlap OL of about 0.025 inches between them when the cutter is in fully closed position. The two jaws move toward each other up to the stop defined by the integrated closed stop formed in the head. The cutting jaws completely close and the lead or wire or cable can be cut completely. The jaws can form a diamond cut on the cable.

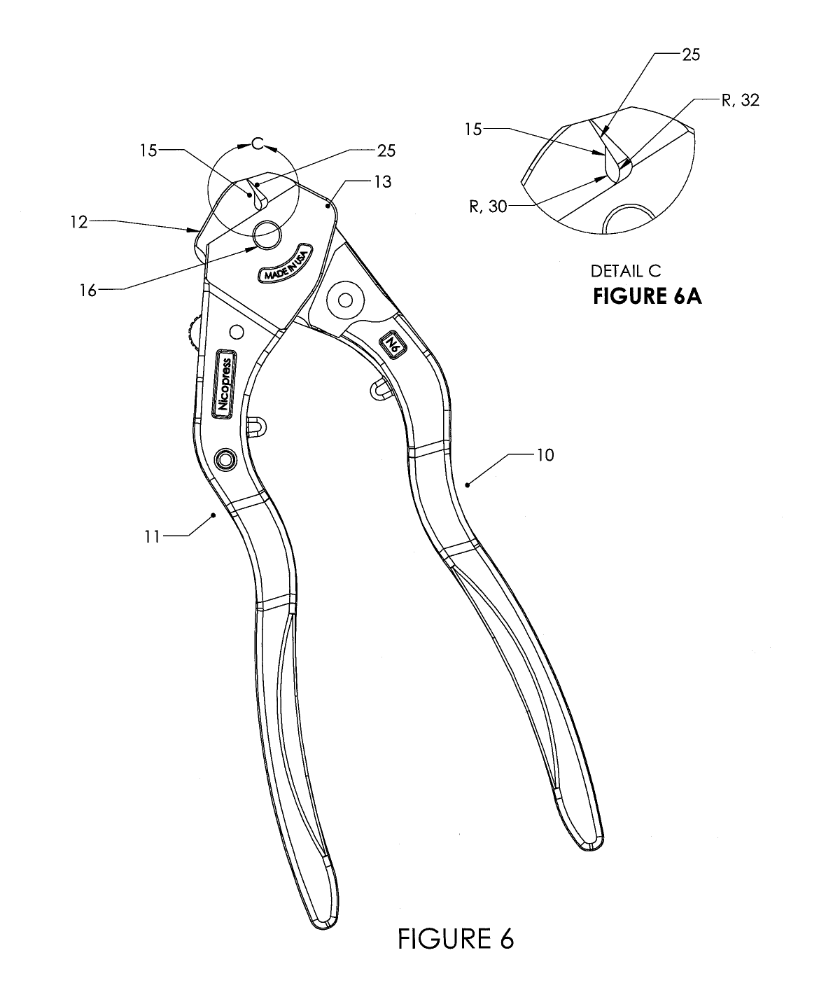

Referring now to FIGS. 6 and 6A, the profile geometry is shown to squeeze a wire rope into a triangular shape with two corners defined by the radius R as the cut is being made.

In particular, the disclosure has a unique cutter profile that allows improved mechanical advantage while maintaining limits defined by the jaw opening, one hand operation, and a quality finished cut. The mechanical advantage is defined by the ratio of the lever arms about the pivot. More particularly, referring to FIG. 1 a first lever arm L1 of about 6.10 inches is defined by the handle length. Referring to FIG. 2, second lever arm L2 of about 0.242 inches is defined by the distance to the root of the cutter jaw.

The equation is given by:

(L1/L2)*(handle force)=(jaw force)

Critical dimensions as they relate to the center pivot are listed as follows:

Radius R is 0.079 inches±0.005 inches

Lever Arm L2 is 0.242 inches±0.005 inches

Profile P is 0.125 inches±0.005 inches

Overlap OL is 0.025 inches±.0.017 inches

Referring now to FIGS. 2, 4, and 5, the cutter has integral open and closed stops built into the cutter head that allowing safe operation, long life, and simple manufacture.

The cutter is also unique in that positive stops for an open and closed position are integrated into the heads 12, 13 of the cutter. The stops are made of the same material as the head (i.e., steel alloy) and have the same hardness as the head. The hardness is the same for all surfaces involved in stopping and there are no such pinch points near the hand while using the cutter.

Referring to FIG. 2 and FIG. 4, integrated open stop surfaces 50, 52 are formed in the cutter heads 12, 13 wherein an edge of the stop 50 contacts an edge of stop 52 in a fully opened position. Edges of the stops 50, 52 can be rounded or curved or angled in configuration. For example, stop 50 is shown to have curved edges and stop 52 is shown to have angled edges. However, other configurations are contemplated by the disclosure.

Referring to FIG. 2 and FIG. 5, integrated closed surfaces 60, 62 are formed in cutter heads 12, 13 in which stop surface 60 contacts stop surface 62 in a fully closed position. Each of the stops are made of the same hardness material as the heads and are integrally machined into the cutter heads. Edges of the stops 60, 62 can be rounded or curved or angled in configuration. For example, stops 60, 62 are shown to have curved surfaces which abut each other. However, other configurations are contemplated by the disclosure.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A hand held cable cutter comprising:
a first cutter half having a first cutting head with a first jaw having a first cutting blade formed on a first cutting edge of said first jaw;
a first pivot portion formed in said first cutting head;
a second cutter half having a second cutting head with a second jaw having a second cutting blade formed on a first cutting edge of said second cutting blade;
a second pivot portion formed in said second head; and
wherein said first cutting blade has a cutting profile formed between said first pivot portion and said first cutting edge of said first cutting blade and a root formed between a second cutting edge of said first cutting blade and said first pivot portion, wherein said second cutting blade has a cutting profile formed between said second pivot portion and said first cutting edge of said second cutting blade and a root formed between a second cutting edge of said second cutting blade and said second pivot portion;
wherein said root and profile of said first cutting blade and said root and profile of said second cutting blade form an overlap between said first and second cutter blades when said cutter is in a closed position.

2. The cutter of claim 1, wherein said overlap is about 0.25 inches.

3. The cutter of claim 1, wherein a radius portion is formed between said first cutting edge and said second cutting edge of said first cutter blade.

4. The cutter of claim 3, wherein said first cutting edge and said second cutting edge of said first cutting blade are oriented about 90 with respect to each other.

5. The cutter of claim 1, wherein a radius portion is formed between said first cutting edge and said second cutting edge of said second cutter blade.

6. The cutter of claim 5, wherein said first cutting edge and said second cutting edge of said second cutting blade are oriented about 90 with respect to each other.

7. The cutter of claim 1, wherein said first cutter head comprises a first handle portion extending from said first cutter head.

8. The cutter of claim 7, wherein said second cutter head comprises a second handle portion extending from said second cutter head.

9. The cutter of claim 1, wherein said first cutter half and said second cutter half are fabricated from a steel alloy.

10. The cutter of claim 1, wherein said cutting profile of said first cutting blade is about 0.125 inches.

11. The cutter of claim 1, wherein said cutting profile of said second cutting blade is about 0.125 inches.

12. The cutter of claim 1, wherein said root of said first cutting blade has a dimension of about 0.242 inches.

13. The cutter of claim 1, wherein said root of said second cutting blade has a dimension of 0.242 inches.

14. The cutter of claim 3, wherein said radius portion of said first cutter blade has a dimension of about 0.079 inches.

15. The cutter of claim 5, wherein said radius portion of said second cutter blade has a dimension of about 0.079 inches.

16. The cutter of claim 7, wherein a first lever arm is formed between said pivot portion of said first cutting head and an outer edge of said first handle portion in a longitudinal direction and is about 6.10 inches in length.

17. The cutter of claim 16, wherein a second lever arm is formed between said pivot portion of said first cutting head and an outer edge of said first handle portion in a transverse direction and is about 3.31 inches in length.

18. The cutter of claim 1, wherein an opening of about 0.27 inches is formed between said first cutter half and said second cutter half in an opened position.

19. The cutter of claim 17, wherein a mechanical advantage is defined by the first lever arm divided by the second lever arm times handle force which equals jaw force.

20. The cutter of claim 1, wherein said first cutter half and said second cutter half each has integrated stop portions formed in said first and second cutting heads to limit movement of said cutter halves to an open or closed position.

21. A hand held cable cutter comprising:
a first and second cutter half each comprising a cutting head having a pivot portion formed therein, and a handle portion extending from said cutting head;
wherein a first lever arm is formed between said pivot portion of said cutting head and an outer edge of said handle portion in a longitudinal direction;
a second lever arm is formed between said pivot portion of said cutting head and an outer edge of said handle portion in a transverse direction; and
wherein a mechanical advantage is defined by the first lever arm divided by the second lever arm times handle force which equals jaw force.
